(19) United States
(12) Patent Application Publication
(10) Pub. No.: US 2015/0369767 A1
(43) Pub. Date: Dec. 24, 2015

(54) ANISOTROPIC MULTIPHYSICS SENSING SYSTEMS FOR MATERIALS AND METHODS OF USING THE SAME

(71) Applicants: John C. Steuben, Lakewood, CO (US); Cameron J. Turner, Golden, CO (US); Douglas Lee Van Bossuyt, Golden, CO (US)

(72) Inventors: John C. Steuben, Lakewood, CO (US); Cameron J. Turner, Golden, CO (US); Douglas Lee Van Bossuyt, Golden, CO (US)

(21) Appl. No.: 14/747,695

(22) Filed: Jun. 23, 2015

Related U.S. Application Data
(60) Provisional application No. 62/015,609, filed on Jun. 23, 2014.

(51) Int. Cl. G01N 27/04; G01N 27/22

(52) U.S. Cl. CPC G01N 27/041; G01N 27/221

(57) ABSTRACT

The present invention is directed to a method to measure a non-electrical property of an object using an electrical property measurement, and applications for the method. The invention is also directed to a transducer, and uses for the transducers.

### CROSS REFERENCE TO RELATED APPLICATIONS

This application claims priority and the benefit under 35 U.S.C. §119(e) to U.S. Provisional Patent Application Ser. No. 62/015,609 filed Jun. 23, 2014, which is incorporated herein in its entirety by reference.

### FIELD OF THE INVENTION

The present invention relates to methods to measure physical properties of objects in a non-destructive manner. In particular, the invention relates to a method by which properties of layered material objects may be determined utilizing electro-magnetic measurements.

### BACKGROUND

In layered manufacturing, objects are constructed by the successive placement of layers of materials by various means. Some common examples include fused filament fabrication, 3-D printing, or the layup of fiber-reinforced polymeric composites. During the production process, the layers are bonded to one another in order to produce structurally sound components. The properties of these bonds differ from those of the bulk feed stock material properties. The parts produced from many of these bonds tend to exhibit orthotropic or otherwise anisotropic behaviors. The bonding itself constitutes several interrelated physical processes, including thermal conduction/convention, material diffusion, and fluid flow. Feedstock materials can be “doped” in order to produce a lower or higher degree of electrical conductivity, then the multiphysics process of bonding will affect electro-magnetic properties along with other properties of the part produced (e.g. mechanical strength). As a result, electro-magnetic properties (e.g. resistance) may be used to indirectly verify properties which are difficult to measure, such as ultimate mechanical strength.

### SUMMARY

The present invention relates to anisotropic (i.e. direction dependent) multiphysics behaviors of layered materials (LM) may be used to measure physical properties of objects produced using various manufacturing techniques in a non-destructive manner. In particular, the method may utilize electrical measurements.

The method has broad applications. For example, the method may be used for quality assurance or quality control for objects constructed with a 3-D printer, other layered fabrication techniques or other fabrication techniques. The quality assurance or control may be assessed either during or following fabrication. The method may also be used for process qualification for low run layered manufacturing production. Other applications include prognostics health management (PHM) for in-service layered-manufactured components, tamper-proof seals/indicators, passive temperature sensing devices, or passive capacitive or other energy storage devices.

An aspect of the invention is a method for detecting at least one physical property of a layered material. The method includes providing an electrical current to the layered material, and measuring a resistance in the layered material. At least one physical property of the layered material is determined based at least partially on the resistance measurement.

An aspect of the invention is a method of measuring at least one mechanical property of an object. The method includes exposing the object to a condition, then measuring an electrical property of the object. At least one non-electrical property of the object is determined from the electrical property while the object is exposed to the condition.

An aspect of the invention is a transducer. The transducer is a layered material formed with a 3-D printer. An electrical property in the transducer is measured to determine a change in a non-electrical property.

### BRIEF DESCRIPTION OF THE DRAWINGS

FIG. 1 illustrates an embodiment of the invention with a 3-D printer and a cooling fan;

FIG. 2 illustrates the resistivity measurement as a function of time for a sample;

FIG. 3 illustrates a transducer in the shape of a spring;

FIG. 4 illustrates a transducer in the shape of a beam; and

FIG. 5 illustrates the resistance as a function of time for a beam shaped transducer and a spring shaped transducer.

### DETAILED DESCRIPTION

The present invention relates to a method to measure properties of a layered material. The method allows for measurements in a non-destructive manner. Another aspect of the invention is a transducer, which can be used in broad applications.

An aspect of the present invention is method for detecting at least one physical property of a layered material. The method includes providing an electrical current to the layered material, then measuring a resistance in the layered material. At least one physical property of the layered material is based at least partially on the resistance measurement. In some embodiments, the physical property can be based solely on the resistance measurement.

The layered material can be a product of a 3-D printer in some embodiments. The layered material can be a composite, a metal, a cermet, a ceramic, a polymer or combinations of each component.

The resistance in the layered material can be provided with a controller. The controller can be controlled with software on a computer. In some embodiments, the controller can also measure and/or collect the resistance measurements and determine the physical properties of the layered material.

The physical property can be a thermal property, a mechanical property and combinations thereof. The mechanical property can be at least one of damage parameters, elastic stiffness and compliance tensors, compressive strength, ductility, fatigue limit, flexural modulus, flexural strength, fracture toughness hardness, plasticity, Poisson's ratio, resilience, shear modulus, shear strain, shear strength, specific modulus, specific strength, specific weight, tensile strength, yield strength, young's modulus, coefficient of friction, coefficient of restitution, roughness, strength, and combinations thereof. The thermal property can be autoignition temperature, binary phase diagram, boiling point, coefficient of thermal expansion, critical temperature, curie point, emissivity, eutectic point, flammability, flash point, glass transition temperature, heat of fusion, heat of vaporization, inversion temperature, melting point, phase diagram, pyrophoricity, solidus, specific heat, thermal conductivity, thermal diffusivity, thermal expansion, Seebeck coefficient, triple point, vapor pressure, softening point, and combinations thereof. In some embodiments, both thermal properties and mechanical properties can be determined. Importantly, the layered material need not be destroyed when determining either a thermal property or a mechanical property of the layered material. In some embodiments, the layered material may be tested during production of the layered material.

The physical property of the layered material can be measured when the layered material is exposed to a condition. In some embodiments, the condition can be a temperature exposure, a force exposure, displacement exposure, electromagnetic field exposure, ionizing or non-ionizing radiation, or combinations thereof. At least two electrodes can be used to measure an electrical property of the layered material. A system can be utilized to collect measurements of the electrical properties. A system can also be used to determine the non-electrical properties of the layered material.

An aspect of the invention is a method of measuring at least one mechanical property of an object. The method includes exposing the object to a condition, measuring an electrical property of the object, and determining the at least one non-electrical property of the object from the electrical property while the object is exposed to the condition. In some embodiments, the measurement of the electrical property can also occur before the condition can be applied or after the condition can be removed, and these additional measurements may also be used to determine a non-electrical property of the object.

The object can be a product of a 3-D printer in some embodiments. The material of the object can be a composite, a metal, a cermet, a ceramic, a polymer or combinations of each component. In some embodiments, the object can be a layered material. The object can be formed using any method, including but not limited to, 3-D printing, injection molding, casting, layering, molding, forming, sintering, or additive manufacturing. In embodiments where a material of the object is not electrically conductive, a dopant can be added to the material. The dopant can be chosen to correspond to an electrical property to be measured. Suitable dopants, include, but are not limited to metals, carbon material (e.g. graphine), organic compounds, ceramics, semiconductors, metalloids (e.g. boron) and the like. In some embodiments, the material of the object can be measured, where a starting material is non-conductive. For example, in a molding operation, the starting material can be wax, which may not be electrically conductive. The resistance of the wax can be initially measured during formation of the object, as the wax is replaced with the final material, for example a metal. The electrical property can change and be measured as the wax is replaced with the metal.

The electrical property that is measured can be any suitable property. By way of example the property may be resistance, conductance, electromagnetic property, capacitance, inductance, impedance, admittance, electromagnetic permittivity and the like.

The electrical property can be determined using suitable methods. For example, a current can be provided to the object and measured across the sample. The electrical current can be provided with a controller. The controller can be controlled with software on a computer. In some embodiments, the controller can also collect the electrical property measurements and determine the physical properties of the object.

The physical property can be a thermal property, a mechanical property and combinations thereof. The mechanical property can be at least one of damage parameters, elastic stiffness and compliance tensors, compressive strength, ductility, fatigue limit, flexural modulus, flexural strength, fracture toughness hardness, plasticity, Poisson's ratio, resilience, shear modulus, shear strain, shear strength, specific modulus, specific strength, specific weight, tensile strength, yield strength, young's modulus, coefficient of friction, coefficient of restitution, roughness, strength, stress property, impact strength, torsion, bending strength, creep, interlayer lamination, and combinations thereof. The thermal property can be autoignition temperature, binary phase diagram, boiling point, coefficient of thermal expansion, critical temperature, curie point, emissivity, eutectic point, flammability, flash point, glass transition temperature, heat of fusion, heat of vaporization, inversion temperature, melting point, phase diagram, pyrophoricity, solidus, specific heat, thermal conductivity, thermal diffusivity, thermal expansion, Seebeck coefficient, triple point, vapor pressure, softening point, and combinations thereof. In some embodiments, both thermal properties and mechanical properties can be determined. Importantly, the object need not be destroyed when determining either a thermal property or a mechanical property of the object. In some embodiments, the object may be tested during production of the object or after the object has been produced, for example quality control.

The physical property of the object can be measured when the object is exposed to a condition. In some embodiments, the condition can be a temperature exposure, a force exposure, displacement exposure, electromagnetic field exposure, ionizing or non-ionizing radiation, or combinations thereof. At least two electrodes can be used to measure an electrical property of the object. A system can be utilized to collect measurements of the electrical properties. A system can also be used to determine the non-electrical properties of the object.

The present invention of measuring induced electrical properties in the object such as bonded LM systems, for example, has several applications. The most obvious of these applications is in the field of non-destructive testing for quality assurance or quality control applications. Electrical conductivity measurements can be taken with inexpensive equipment can be correlated to mechanical properties which typically require destructive testing and expensive equipment to measure. Additionally, these measurements can be taken during the production process, allowing for on-line quality control measurements.

The present invention can be extended to the field of process qualification—that is demonstrating that a production process reliably produces satisfactory output. Another application of the present invention is in the field of prognostic health management. The properties of LM parts can be measured electrically while in service or under loading in order to predict or prevent failures. Another application is a new type of tamper-proof indicators for high-security applications. If a seal produced using LM is broken, reassembly of the seal by thermal, chemical, or other means will change the bonds structure of the LM material and result in an easily detected change in electrical response. Electrical properties of LM systems are strongly temperature dependent. This implies that these systems can also be used as passive temperature sensing elements.

Other applications include, but are not limited to, low power monitoring applications (including border crossing/footfall sensors, windspeed sensors on, for example, aircraft wings, wind turbine airfoils, or icing sensors), PHM, part qualification, quality control, manufacturing control, other inspections or other similar activities.

Another aspect of the invention is the monitoring of properties of an object during manufacturing. By way of example, an object can be a layered material, which can be manufactured on a build plate. The build plate can be made of a conductive material, such as a metal plate, metal foil, a conductive polymer, or a conductive material (for example metal wires) placed on a non-conductive or conductive plate material, and combinations thereof. Non-conductive plate materials include, but are not limited to, polymers, glass, ceramics, woods and non-conductive composites. The object can be made from any suitable material, including but not limited to, ABS, conductive ABS, plastic (including acrylic, castable wax, elastomeric, polyamide, nylon, resin), sandstone, gypsum, graphine, carbon black doped plastic, metal (including but not limited to platinum, gold, silver, titanium, precious plated metal, brass, bronze, steel, alloys thereof and the like), ceramic, bio materials, and combinations thereof. In some embodiments, ABS (which can be in the form of a slurry) or another glue, for example polyvinyl acetate based glue, can be applied to the plate in order to increase the bond between the build plate and the material of the object, thereby increasing the yield of the material applied to the plate. In some embodiments, the material of the object can include a dopant. The nozzle, which can be used to apply the material of the object, can be conductive. The nozzle is able to withstand the operating temperature of process, which is the determined by the material of the object. By way of non-limiting example, the nozzle can be made from a metal, such as a brass nozzle, copper, steel, stainless steel, alloys thereof or the like. In some embodiments, electrical connection points can be placed on the nozzle and the build plate. In some embodiments, the electrical connection points can be placed on the object in a location where the material has cooled after manufacturing. In some embodiments, an electrical connection point to contact the material can be a probe that follows the nozzle and contacts material that has been laid down by the nozzle. The electrical connection points can be connected to leads, which can be connected to a multimeter. In some embodiments, the multimeter can be connected to a system to collect measurements and/or monitor the electrical measurement across the nozzle and build plate during manufacturing of the object. In some embodiments, a system can be used to adjust parameters of the nozzle and surrounding system to known or preferred properties. By way of example, if an object with known or preferred properties during manufacturing is known, then the object can be monitored and parameters adjusted in order to produce an object with similar properties to the known or preferred properties.

The placement of the connection point to the material of the object can depend on the material of the object, and can also depend upon the dopant and the amount of dopant used in the material. By way of example, if the material of the object contains carbon black, especially low quantities of carbon black (less than about 10% by weight), then the electrical measurement cannot be sufficiently measured. In these situations, an electrical connection point can be a probe that follows the nozzle. The probe can be any suitable distance from the nozzle. In some embodiments, the probe can be between about 1 mm to about 20 cm away from the nozzle. In some embodiments, the distance between the nozzle and the probe can be about 1 mm, about 5 mm, about 1 cm, about 1.5 cm, about 2 cm, about 2.5 cm, about 3 cm, about 3.5 cm, about 5 cm, about 10 cm, about 15 cm, or about 20 cm. In some embodiments, the probe can be positioned such that it travels along the same plane as the nozzle. By way of another example, in some embodiments, the material of the object or the dopant of the object may contain graphine. In these embodiments, it can be possible to measure an electrical measurement from the nozzle as the material is laid.

The nozzle/extruder temperature can be between about 190-350° C. In some embodiments, the nozzle temperature can be about 190° C., about 200° C., about 210° C., about 220° C., about 230° C., about 240° C., about 250° C., about 260° C., about 270° C., about 280° C., about 290° C., about 300° C., about 310° C., about 320° C., about 330° C., about 340° C., or about 350° C. The plate temperature can be between about 50-100° C. In some embodiments, the plate temperature can be about 50° C., about 60° C., about 70° C., about 80° C., about 90° C., or about 100° C. The nozzle/extruder temperature and/or the plate temperature can be controlled by a controller, with software or by a computer, wherein the temperature can be maintained within about 1 degree, in some embodiments, within about 0.5 degrees.

An aspect of the invention is a method to monitor the parameters of an object during manufacturing. The method includes preparing a comparison object and monitoring at least one electrical property during the manufacturing of the comparison object. At least one property of the comparison object can be measured following manufacturing, which is evaluated to determine whether the property of the comparison object is acceptable. A second object can be prepared and the same property monitored during manufacturing. If the property is not within a tolerance during manufacturing, adjust at least one parameter of the manufacturing process can be adjusted until the property is within tolerance. The parameters that could be varied include, but are not limited to, manufacturing temperature, speed material is placed, cooling rate, environmental temperature, layer dwell time, material deposition geometry, layer thickness, and combinations of the parameters.

Another aspect of the invention is a transducer produced using conductive LM technology, which have widespread applications in many fields. Notably, this invention allows for strain transducers to be produced within structures during their manufacture (e.g. deposited within an otherwise conventional 3-D printed component), which opens many opportunities for prognostic health management as described earlier. The transducer can be any suitable shape, including a spring, or a beam. The spring transducers may have any number of “turns” in the spring. The greater the number of “turns”, then the greater the change in voltage when a parameter, such as a force, is applied then released.

An aspect of the invention is a transducer. The transducer may be made of a layered material that can be formed with a 3-D printer. The electrical property in the transducer is measured to determine a change in a non-electrical property.

The non-electrical property can be at least one of mechanical strain, displacement, mechanical stress, temperature, delamination, cracking, and damage parameters (which may include, for example, identification of tampering).

### EXAMPLES

### Example 1

The resistance for multiple samples prepared for varying thicknesses was tested. The test slugs were 8 mm diameter by 20 mm long solid cylinder printed at 100% infill. An extrusion temperature of 220 degrees Celsius and the build plate temperature was 100 degrees Celsius. The slugs were glued down with Elmer's purple glue but then washed before testing. The print speed was set to 40 mm/s. A 4 mm nozzle with 1.75 mm filament was used to prepare the samples. The number of layers were as follows: for the 0.4 mm samples: 50 layers; for the 0.3 mm: 67 layers; for the 0.2 mm: 100 layers. The overall dimensions remained the same for all of the samples (i.e. 8 mm diameter by 20 mm long). Table 1 illustrates four sample sets for the 0.4 mm samples, along with the average, and standard deviation for each sample set.

TABLE 1

| Sample # | Run 1 | Run 2 | Run 3 | Run 4 |
|---|---|---|---|---|
| 1 | 0.469 | 0.498 | 0.611 | 0.485 |
| 2 | 0.513 | 0.474 | 0.526 | 0.448 |
| 3 | 0.471 | 0.536 | 0.627 | 0.498 |
| 4 | 0.474 | 0.507 | 0.608 | 0.481 |
| 5 | 0.519 | 0.466 | 0.594 | 0.551 |
| 6 | 0.638 | 0.492 | 0.461 | 0.481 |
| 7 | 0.481 | 0.465 | 0.464 | 0.541 |
| 8 | 0.525 | 0.54 | 0.518 | 0.514 |
| 9 | 0.684 | 0.427 | 0.49 | 0.522 |
| 10 | 0.534 | 0.449 | 0.478 | 0.473 |
| 11 | 0.561 | 0.473 | 0.508 | 0.481 |
| 12 | 0.509 | 0.495 | 0.541 | 0.463 |
| 13 | 0.523 | 0.458 | 0.516 | 0.503 |
| 14 | 0.571 | 0.516 | 0.486 | 0.52 |
| 15 | 0.459 | 0.481 | 0.481 | 0.588 |
| 16 | 0.458 | 0.498 | 0.453 | 0.423 |
| 17 | 0.466 | 0.498 | 0.652 | 0.493 |
| 18 | 0.516 | 0.433 | 0.609 | 0.703 |
| 19 | 0.473 | 0.492 | 0.433 | 0.448 |
| 20 | 0.45 | 0.498 | 0.546 | 0.459 |
| 21 | 0.516 | 0.471 | 0.461 | 0.481 |
| 22 | 0.445 | 0.485 | 0.546 | 0.593 |
| 23 | 0.452 | 0.56 | 0.531 | 0.493 |
| 24 | 0.565 | 0.481 | 0.546 | 0.613 |
| 25 | 0.443 | 0.48 | 0.491 | 0.547 |
| 26 | 0.506 | 0.504 | 0.548 | 0.451 |
| 27 | 0.485 | 0.435 | 0.471 | 0.501 |
| 28 | 0.57 | 0.463 | 0.569 | 0.509 |
| 29 | 0.501 | 0.473 | 0.516 | 0.424 |
| 30 | 0.477 | 0.478 | 0.465 | 0.537 |
| Average | 0.508 | 0.484 | 0.525 | 0.507 |
| Std Dev. | 0.055 | 0.030 | 0.057 | 0.059 |
| % Std Dev. | 10.90% | 6.13% | 10.85% | 11.53% |

Table 2 illustrates four sample sets for the 0.3 mm samples, along with the average, and standard deviation for each sample set.

TABLE 2

| Sample # | Run 1 | Run 2 | Run 3 | Run 4 |
|---|---|---|---|---|
| 1 | 0.36 | 0.394 | 0.41 | 0.435 |
| 2 | 0.395 | 0.395 | 0.335 | 0.425 |
| 3 | 0.438 | 0.441 | 0.475 | 0.395 |
| 4 | 0.363 | 0.435 | 0.387 | 0.465 |
| 5 | 0.448 | 0.498 | 0.381 | 0.361 |
| 6 | 0.403 | 0.363 | 0.377 | 0.51 |
| 7 | 0.525 | 0.36 | 0.384 | 0.402 |
| 8 | 0.423 | 0.322 | 0.368 | 0.458 |
| 9 | 0.353 | 0.375 | 0.43 | 0.413 |
| 10 | 0.352 | 0.46 | 0.367 | 0.374 |
| 11 | 0.397 | 0.401 | 0.397 | 0.523 |
| 12 | 0.383 | 0.413 | 0.351 | 0.575 |
| 13 | 0.535 | 0.432 | 0.386 | 0.365 |
| 14 | 0.418 | 0.408 | 0.353 | 0.451 |
| 15 | 0.501 | 0.395 | 0.441 | 0.534 |
| 16 | 0.401 | 0.432 | 0.363 | 0.528 |
| 17 | 0.445 | 0.364 | 0.342 | 0.488 |
| 18 | 0.426 | 0.503 | 0.405 | 0.338 |
| 19 | 0.329 | 0.408 | 0.381 | 0.425 |
| 20 | 0.461 | 0.365 | 0.391 | 0.415 |
| 21 | 0.398 | 0.342 | 0.389 | 0.575 |
| 22 | 0.38 | 0.421 | 0.342 | 0.416 |
| 23 | 0.365 | 0.429 | 0.411 | 0.375 |
| 24 | 0.355 | 0.501 | 0.485 | 0.416 |
| 25 | 0.381 | 0.437 | 0.335 | 0.427 |
| 26 | 0.465 | 0.457 | 0.401 | 0.488 |
| 27 | 0.372 | 0.369 | 0.331 | 0.374 |
| 28 | 0.422 | 0.341 | 0.321 | 0.35 |
| 29 | 0.382 | 0.383 | 0.384 | 0.329 |
| 30 | 0.425 | 0.352 | 0.421 | 0.375 |
| Average | 0.410 | 0.407 | 0.385 | 0.434 |
| Std Dev. | 0.050 | 0.047 | 0.039 | 0.067 |
| % Std Dev. | 12.22% | 11.59% | 10.15% | 15.51% |

Table 3 illustrates four sample sets for the 0.2 mm samples, along with the average, and standard deviation for each sample set.

TABLE 3

| Sample # | Run 1 | Run 2 | Run 3 | Run 4 |
|---|---|---|---|---|
| 1 | 0.188 | 0.177 | 0.216 | 0.194 |
| 2 | 0.205 | 0.195 | 0.205 | 0.182 |
| 3 | 0.193 | 0.194 | 0.209 | 0.206 |
| 4 | 0.213 | 0.188 | 0.204 | 0.179 |
| 5 | 0.204 | 0.19 | 0.187 | 0.186 |
| 6 | 0.203 | 0.185 | 0.19 | 0.177 |
| 7 | 0.191 | 0.185 | 0.188 | 0.191 |
| 8 | 0.236 | 0.193 | 0.174 | 0.19 |
| 9 | 0.233 | 0.187 | 0.203 | 0.207 |
| 10 | 0.21 | 0.201 | 0.193 | 0.208 |
| 11 | 0.206 | 0.236 | 0.182 | 0.177 |
| 12 | 0.188 | 0.235 | 0.201 | 0.195 |
| 13 | 0.236 | 0.191 | 0.185 | 0.183 |
| 14 | 0.195 | 0.193 | 0.176 | 0.196 |
| 15 | 0.203 | 0.194 | 0.187 | 0.215 |
| 16 | 0.234 | 0.197 | 0.246 | 0.201 |
| 17 | 0.2 | 0.189 | 0.181 | 0.188 |
| 18 | 0.197 | 0.182 | 0.239 | 0.208 |
| 19 | 0.209 | 0.193 | 0.201 | 0.187 |
| 20 | 0.225 | 0.183 | 0.181 | 0.191 |
| 21 | 0.226 | 0.181 | 0.19 | 0.184 |
| 22 | 0.208 | 0.201 | 0.221 | 0.179 |
| 23 | 0.229 | 0.193 | 0.213 | 0.194 |
| 24 | 0.185 | 0.189 | 0.18 | 0.182 |
| 25 | 0.228 | 0.184 | 0.178 | 0.179 |
| 26 | 0.203 | 0.184 | 0.168 | 0.195 |
| 27 | 0.209 | 0.235 | 0.178 | 0.191 |
| 28 | 0.177 | 0.232 | 0.19 | 0.187 |
| 29 | 0.199 | 0.202 | 0.186 | 0.177 |
| 30 | 0.206 | 0.213 | 0.174 | 0.174 |
| Average | 0.208 | 0.197 | 0.194 | 0.190 |
| Std Dev. | 0.016 | 0.016 | 0.018 | 0.011 |
| % Std Dev. | 7.70% | 8.37% | 9.52% | 5.63% |

The results from Tables 1-3 illustrate a clear difference in resistance based upon layer height, but also illustrate consistency across samples of the same layer height.

### Example 2

Printed test slugs that were 8 mm by 20 mm overall length, upright orientation were made from conductive ABS filament (1.75 mm/1 kg). The extruder temperature (T_{C}) was about 240° C., the build plate temperature (T_{L}) was about 110° C., the speed of the extruder head relative to the build plate (Vₜ) was about 40 mm/s and the thickness varied for several samples such that the thickness was about 0.15 mm, or 0.3 mm. Three samples of slugs were made at each thickness. Table 4 illustrates the results from this testing.

TABLE 4

| | Resistance (kΩ) | | | |
|---|---|---|---|---|
| Thickness | Sample 1 | Sample 2 | Sample 3 | Average |
| 0.15 mm | 46.24 | 49.02 | 51.42 | 48.89 |
| 0.3 mm | 43.12 | 43.61 | 44.63 | 43.79 |

During this test, it was observed that the samples were capacitive and required greater than about 5 minutes of settling time in order to accurately read resistance. A fixture was developed to hold the samples in constant contact with the ohmmeter leads. A clamp held the sample such that there was a first rubber pad, an adhesive foam, a copper electrode, then the sample, followed by the copper electrode, another adhesive foam, and a rubber pad. The test leads were then connected to the copper electrodes such that a positive charge was supplied to one of the copper electrodes and a negative charge was supplied to the other copper electrode.

During the experiment, it was noted that T_{C} of about 240° C. was too high for this material. Furthermore, the resistance should be stable before measurement is taken.

### Example 3

The test parameters of Example 2 was repeated, but with T_{C} at 200° C. Table 5 illustrates the resistance for three samples at two different thicknesses.

TABLE 5

| | Resistance (kΩ) | | | |
|---|---|---|---|---|
| Thickness | Sample 1 | Sample 2 | Sample 3 | Average |
| 0.15 mm | 289.2 | 344.1 | 363.2 | 332.2 |
| 0.3 mm | 175.6 | 217.9 | 194.6 | 196.0 |

The resistance measurement increased when the T_{C} was reduced from 240 C to 200 C. The difference in resistance between layers thickness is now much more pronounced at the lower extrusion mechanism.

### Example 4

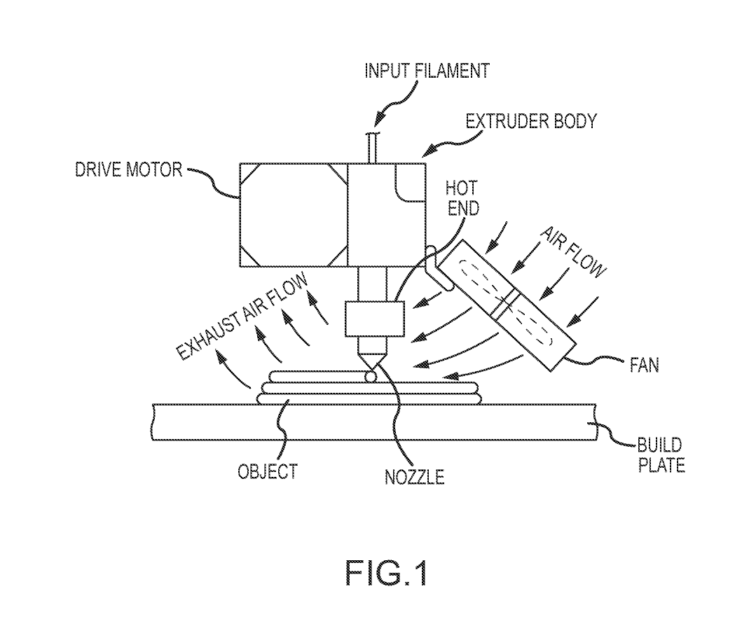

Example 4 was used to gage the effect of cooling fan speeds. By way of example, 3-D printers can be continuously equipped with a cooling fan which can be used to rapidly solidify the polymer extrude as illustrated in FIG. 1. The cooling air rapidly lowers the temperature of the substrate layers of the object. Thus, the speed of the airflow/fan should have a measurable input on the bond properties and thus the resistance measurements.

The Makerbear M2 printer was equipped with an Evercool 50 mm 12 V cooling fan. PWM control was used to vary the fan speed from 0 to 100%. Three samples were printed at 220° C., and the thickness of the samples was 0.2 mm. All other variables remained the same as discussed in Example 2. Table 6 illustrates the resistance for two different fan percentages. Note that the fan was off while the first two layers were printed in order to promote good adhesion of the parts to the print bed.

TABLE 6

| | Resistance (kΩ) | | |
|---|---|---|---|
| Fan % | Sample 1 | Sample 2 | Sample 3 |
| 20 | 71.09 | 69.97 | 64.31 |
| 100 | 147.5 | 133.8 | 82.13 |

The third sample in the 100% fan group shows much lower resistance than the other two. This lower resistance can be due to the relative positions of the three samples during testing as sample 3 was farther from the airflow. The third sample may be receiving less airflow when the fan is on high producing better bonding and conductance. At low fan speeds, this difference should not be as large, as we see in the comparison of samples 1, 2, and 3 in the 20% trial.

### Example 5

In order to test the effects of annealing, the samples from Example 4 were held at an elevated temperature and measured afterward. A fixture was designed to hold them and prevent gross damage caused by radiant heating. The samples were heated to 123° C. and held at this temperature for about 2 hours. The results are illustrated in Table 7.

TABLE 7

| | Resistance (kΩ) | | |
|---|---|---|---|
| Fan % | Sample 1 | Sample 2 | Sample 3 |
| 20 | 13.43 | 10.67 | 11.41 |
| 100 | 10.57 | 11.54 | 10.83 |

The samples were allowed to cool to room temperature before resistance measurements were taken. Mechanical damage appeared on the samples when allowed to cool. It is much more prominent on samples for the fan at 100% than the samples for the fan at 20%. The annealing process appears to be splitting the weak interlayer bonds of the 100% samples. In both sets of samples, the post-annealing resistance is greatly reduced. The low resistance even in the presence of mechanical damage, reinforces the notion that bonding is the dominant determinant of resistance.

### Example 6

Example 6 tested the effect of print-head velocity on sample resistivity. Three samples were printed at 220° C., 25% fan speed, and 0.22 mm layer height at velocities of 10 mm/s and 40 mm/s. The resistance measurements are illustrated in Table 8.

TABLE 8

| | Resistance (kΩ) | | |
|---|---|---|---|
| Velocity (mm/s) | Sample 1 | Sample 2 | Sample 3 |
| 40 | 43.48 | 59.08 | 52.79 |
| 10 | 31.17 | 36.87 | 29.59 |

The printhead velocity has a measurable effect on the sample resistance, which is at a lower magnitude compared to some other manufacturing properties (i.e. T_{c}).

### Example 7

A test was conducted wherein high voltages were applied to test samples in order to drive higher currents through the samples. Three samples were printed with 0.22 mm height, and T_{c} of 220° C., and fan speed at about 25%. After the as printed conductivity of the samples was measured, then each was subjected to a three second jolt from the transformer and again measured for conductivity. The resistance data are illustrated in Table 9.

TABLE 9

| | Resistance (kΩ) | | |
|---|---|---|---|
| | Sample 1 | Sample 2 | Sample 3 |
| Before high voltage | 84.03 | 69.28 | 79.0 |
| exposure | | | |
| After high voltage | 12.61 | 9.92 | 6.81 |
| exposure | | | |

For all samples, the resistance notably drops after being subjected to high voltage current. This reduction in resistance may be a thermal effect as each of the samples were hot to the touch when removed from the test fixture.

### Example 8

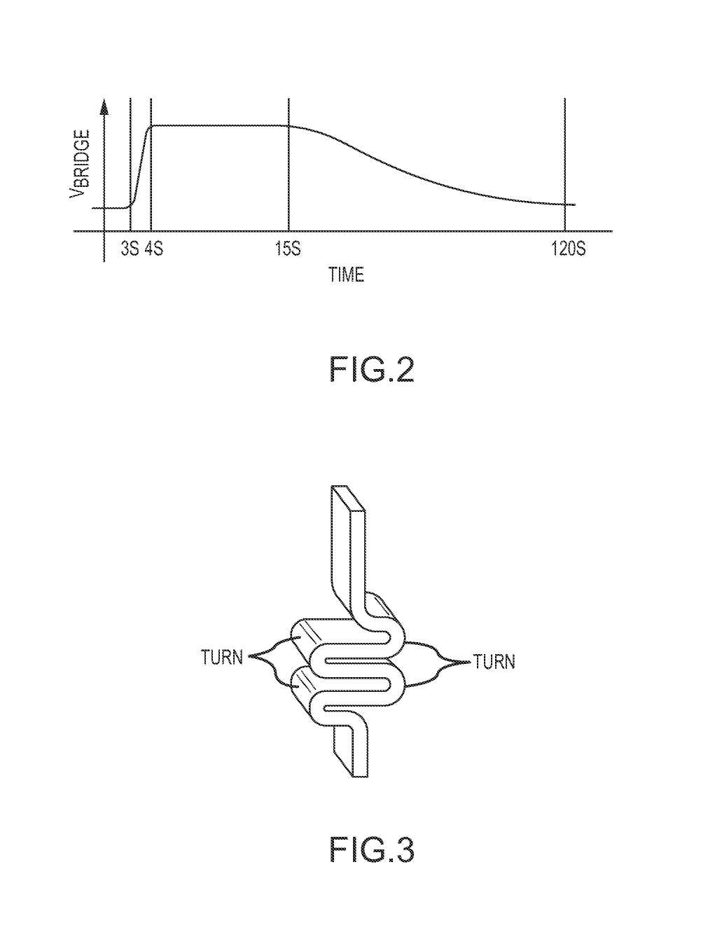

An experiment was conducted to determine the conductivity of an ABS/carbon filament at elevated temperature. An approximately 5 cm length of 1.75 mm thick filament (the feedstock material for Examples 2-7) was suspended between two electrodes that were attached to a Wheatstone bridge. The temperature of the sample was elevated with a heat source (cigarette lighter). The conductivity was recorded from before the heat was applied to the center of the sample, and throughout the remainder of the experiment. Heat was applied (at approximately 3 seconds) until the filament began to soften and sag. The filament solidified (about 15 seconds), then was allowed to cool to room temperature (about 120 seconds). FIG. 2 illustrates the resistivity measurement as a function of time. As the polymer reached the softening point (approximately 4 seconds) the voltage rose to about 6 volts, indicating that the filament has effectively infinite resistance and that the conductive properties of ABS is not present above the softening temperature.

### Example 9

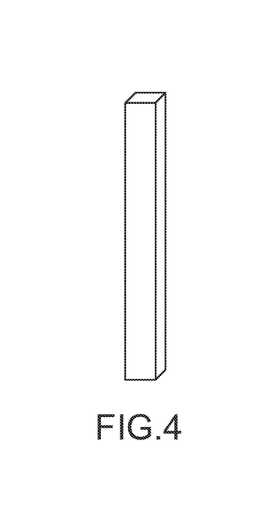

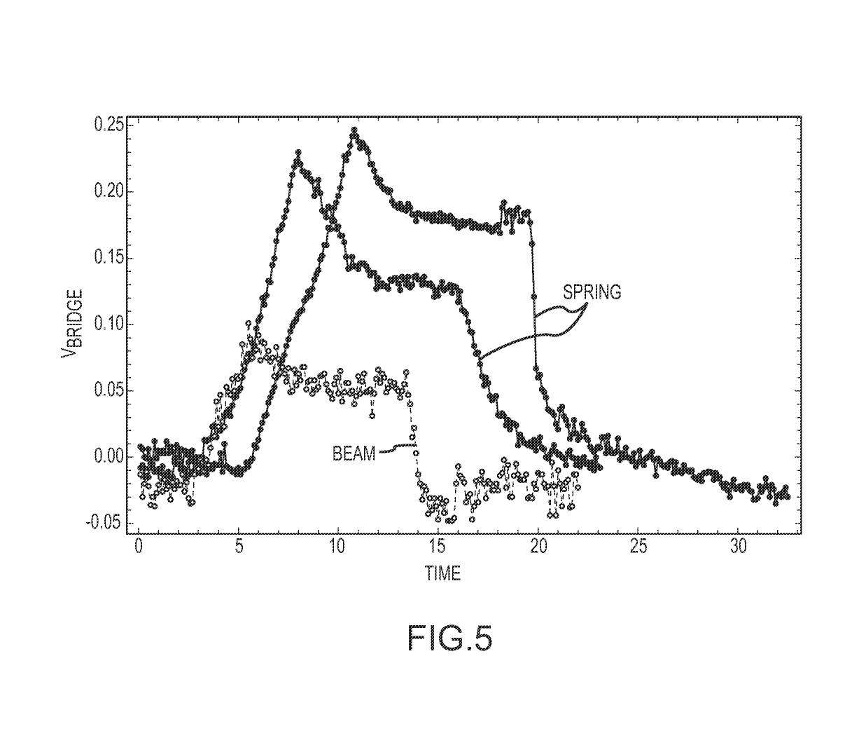

An experiment was conducted to determine if printed structures could be used as transducers. Two shapes were tested in this experiment—a spring and a beam. The spring is illustrated in FIG. 3 and the beam is illustrated in FIG. 4. A load was applied to the transducers and the resistance measured. FIG. 5 illustrates the resistance over time. FIG. 5 illustrates that after the load has been released, there is a measurable change in the resistance to the transducers. The beam sample (dashed line), which is more rigid in the bending mode, and a smaller increase in resistance under the same load conditions as the spring (solid line). This resistance indicates the resistance of a transducer will depend on the stain state of the material, which may be due in part to the build direction and the material of the transducer rather than the bonds between the layers of the material.

The foregoing description of the invention has been presented for illustration and description purposes. However, the description is not intended to limit the invention to only the forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Consequently, variations and modifications commensurate with the above teachings and skill and knowledge of the relevant art are within the scope of the invention. The embodiments described herein above are further intended to explain best modes of practicing the invention and to enable others skilled in the art to utilize the invention in such a manner, or include other embodiments with various modifications as required by the particular application(s) or use(s) of the invention. Thus, it is intended that the claims be construed to include alternative embodiments to the extent permitted by the prior art.

1. A method for detecting at least one physical property of a layered material, comprising:
providing an electrical current to the layered material;
measuring a resistance in the layered material; and
determining at the least one physical property of the layered material based at least partially on the resistance.

2. The method of claim 1, wherein the layered material is a product of a 3-D printer.

3. The method of claim 1, wherein the resistance is provided with a controller.

4. The method of claim 3, wherein the controller is controlled with software on a computer.

5. The method of claim 1, wherein the at least one physical property is at least one of a thermal property, a mechanical property and combinations thereof.

6. The method of claim 5, wherein the mechanical property is at least one of compressive strength, ductility, fatigue limit, flexural modulus, flexural strength, fracture toughness hardness, plasticity, poisson's ratio, resilience, shear modulus, shear strain, shear strength, specific modulus, specific strength, specific weight, tensile strength, yield strength, young's modulus, coefficient of friction, coefficient of restitution, roughness, strength, and combinations thereof.

7. The method of claim 5, wherein the at least one physical property is a thermal property.

8. The method of claim 7, wherein the thermal property is selected from the group consisting of an autoignition temperature, a binary phase diagram, a boiling point, a coefficient of thermal expansion, critical temperature, curie point, emissivity, eutectic point, flammability, flash point, glass transition temperature, heat of fusion, heat of vaporization, inversion temperature, melting point, phase diagram, pyrophoricity, solidus, specific heat, thermal conductivity, thermal diffusivity, thermal expansion, Seebeck coefficient, triple point, vapor pressure, a softening point, and combinations thereof.

9. A method of measuring at least one mechanical property of an object, comprising:
exposing the object to a condition;
measuring an electrical property of the object; and
determining the at least one non-electrical property of the object from the electrical property while the object is exposed to the condition.

10. The method of claim 9, wherein the measurement of the at least one non-electrical property is non destructive.

11. The method of claim 9, wherein the electrical property is at least one of a resistance, a conductance, an electromagnetic property, a capacitance, an inductance, an impedance, an admittance, and an electromagnetic permittivity.

12. The method of claim 9, wherein the electrical property of a material of the object is measured.

13. The method of claim 12, wherein the material is at least one of metal, a cermet, a composite, a ceramic, and a polymer.

14. The method of claim 9, wherein the object comprises a material and a dopant, and wherein the dopant is chosen to correspond to the electrical property.

15. The method of claim 14, wherein the dopant is at least one of a metal, a carbon material, an organic compound, a ceramic, and a semiconductor.

16. The method of claim 15, wherein the metal is at least one of a platinum, a gold, a silver, a titanium, a precious plated metal, a brass, a bronze, a steel and alloys thereof.

17. The method of claim 9, wherein the electrical property is measured during manufacturing of the object.

18. The method of claim 9, wherein the at least one non-electrical property is determined after manufacturing of the object is complete.

19. A transducer, comprising:
a layered material, wherein the layered material is formed with a 3-D printer, and wherein an electrical property in the transducer is measured to determine a change in a non-electrical property.

20. The transducer of claim 19, wherein the non-electrical property is selected from a group comprising at least one of a resistance, a conductance, a electromagnetic property, a capacitance, an inductance, an impedance, an admittance, and an electromagnetic permittivity.
